(19) United States
(12) Patent Application Publication
(10) Pub. No.: US 2023/0416519 A1
(43) Pub. Date: Dec. 28, 2023

(54) Thermoplastic Resin Composition and Molded Product Manufactured Therefrom

(71) Applicant: LOTTE CHEMICAL CORPORATION, Seoul (KR)

(72) Inventors: Hanna KIM, Uiwang-si (KR); Sanghyun HONG, Uiwang-si (KR); Youngsub JIN, Uiwang-si (KR)

(21) Appl. No.: 18/039,039

(22) PCT Filed: Nov. 24, 2021
(86) PCT No.: PCT/KR2021/017409

§ 371 Date: May 26, 2023

(30) Foreign Application Priority Data
Nov. 30, 2020 (KR) 10-2020-0165199

(51) Int. Cl. C08L 55/02

(52) U.S. Cl. CPC C08L 55/02; C08L 2203/30; C08L 2205/035; C08L 2207/53

(57) ABSTRACT

The present invention provides a thermoplastic resin composition and a molded product manufactured therefrom, the thermoplastic resin composition comprising, with respect to 100 parts by weight of a base resin including: (A1) 20-40 wt % of a butadiene-based rubber-modified aromatic vinyl-vinyl cyanide graft copolymer; (A2) 20-50 wt % of an aromatic vinyl-vinyl cyanide copolymer; (B) 5-25 wt % of a polyamide resin; and (C) 10-30 wt % of an N-phenyl maleimide-styrene-maleic anhydride (PMI-SM-MAH) copolymer, (D) 1-15 parts by weight of a polyether-ester-amide block copolymer.

### TECHNICAL FIELD

The present invention relates to a thermoplastic resin composition and a molded product produced therefrom.

### BACKGROUND ART

Styrene-based resins represented by acrylonitrile-butadiene-styrene copolymer (ABS) resins are widely used in various applications due to their excellent formability, mechanical properties, appearance, secondary processability, and the like.

Molded articles produced using styrene-based resins can be applied to various products that do or do not require painting, for example, various interior/exterior materials for automobiles and/or electronic devices.

In some cases, painting is performed on a molded product produced from a styrene-based resin in order to impart aesthetic effects to various interior/exterior materials. In general, painting may be performed by electrostatic painting widely used in the art, but is not limited thereto. Electrostatic painting is a process of performing painting after imparting electrical conductivity to the surface of a molded product and, in order to apply electrostatic coating to a plastic molded product having high surface resistance, it is necessary to perform pretreatment, such as application of a conductive primer and the like, to the surface of the molded product.

Since application of the conductive primer increases the number of processes and a process time, it has been proposed in recent years to further add various conductive materials (for example, carbon nanotubes) and/or additives for expression of conductivity into a styrene-based resin such that a molded product can have a certain level of electrical conductivity.

However, the addition of the conductive material and/or additives for expression of conductivity to the styrene-based resin can cause unexpected degradation in various properties due to damage to property balance of the styrene resin.

Therefore, there is a need for development of a thermoplastic resin composition that can maintain good electrical conductivity and property balance.

### DISCLOSURE

### Technical Problem

Embodiments of the present invention provide a thermoplastic resin composition that has good properties in terms of electrical conductivity, impact resistance, painting adhesion, and waterproof reliability.

Embodiments of the present invention provide a molded product produced therefrom.

### Technical Solution

In accordance with one aspect of the present invention, a thermoplastic resin composition comprises: 100 parts by weight of a base resin comprising 20 to 40 wt % of (A1) a butadiene-based rubber-modified aromatic vinyl-vinyl cyanide graft copolymer, 20 to 50 wt % of (A2) an aromatic vinyl-vinyl cyanide copolymer, 5 to 25 wt % of (B) a polyamide resin; and 10 to 30 wt % of (C) an N-phenyl maleimide-styrene-maleic anhydride (PMI-SM-MAH) copolymer; and 1 to 15 parts by weight of (D) a polyether-ester-amide block copolymer.

The (A1) butadiene-based rubber-modified aromatic vinyl-vinyl cyanide graft copolymer may have a core-shell structure in which the core is composed of a butadiene-based rubber polymer and the shell is formed by graft polymerization of an aromatic vinyl compound and a vinyl cyanide compound to the core.

The butadiene-based rubber polymer may have an average particle diameter of 0.2 to 1.0 μm.

The (A1) butadiene-based rubber-modified aromatic vinyl-vinyl cyanide graft copolymer may be an acrylonitrile-butadiene-styrene graft copolymer (g-ABS).

The (A2) aromatic vinyl-vinyl cyanide copolymer may comprise 55 to 80 wt % of an aromatic vinyl compound-derived component and 20 to 45 wt % of a vinyl cyanide compound-derived component based on 100 wt %.

The (A2) aromatic vinyl-vinyl cyanide copolymer may have a weight average molecular weight of 80,000 to 300,000 g/mol.

The (A2) aromatic vinyl-vinyl cyanide copolymer may be a styrene-acrylonitrile copolymer.

The (B) polyamide resin may comprise polyamide 6, polyamide 66, polyamide 46, polyamide 11, polyamide 12, polyamide 610, polyamide 612, polyamide 61, polyamide 6T, polyamide 4T, polyamide 410, polyamide 510, polyamide 1010, polyamide 1012, polyamide 10T, polyamide 1212, polyamide 12T, polyamide MXD6, or a combination thereof.

The (C)N-phenyl maleimide-styrene-maleic anhydride (PMI-SM-MAH) copolymer may comprise 20 to 55 wt % of an N-phenyl maleimide-derived component based on 100 wt %.

The (C)N-phenyl maleimide-styrene-maleic anhydride (PMI-SM-MAH) copolymer may have a glass transition temperature (Tg) of 150 to 200° C.

The (D) polyether-ester-amide block copolymer may be a reaction mixture of: an aminocarboxylic acid, lactam, or diamine-dicarboxylic acid salt having 6 or more carbon atoms; a polyalkylene glycol; and a dicarboxylic acid having 4 to 20 carbon atoms.

In one embodiment, the thermoplastic resin composition may further comprise at least one selected from flame retardants, nucleating agents, coupling agents, fillers, plasticizers, impact modifiers, lubricants, antibacterial agents, release agents, heat stabilizers, antioxidants, UV stabilizers, pigments, and dyes.

In accordance with another aspect of the present invention, there is provided a molded product produced from the thermoplastic resin composition set forth above.

### Advantageous Effects

The present invention provides a thermoplastic resin composition exhibiting good properties in terms of electrical conductivity, impact resistance, painting adhesion and waterproof reliability, and a molded product using the same.

In addition, the thermoplastic resin composition and the molded product produced therefrom exhibit good electrical conductivity and property balance to be widely applied to various products used with painting or without painting, particularly to a molded product requiring electrostatic painting.

### BEST MODE

Hereinafter, exemplary embodiments of the present invention will be described in detail. However, it should be understood that the following embodiments are provided by way of example and the present invention is not limited thereto and is defined only by the appended claims.

Unless otherwise specified, “copolymerization” means block copolymerization, random copolymerization, or graft copolymerization, and “copolymer” means a block copolymer, a random copolymer, or a graft copolymer.

Unless otherwise specified, the average particle diameter of a rubber polymer is a volume average diameter and means a Z-average particle diameter measured using a dynamic light scattering analyzer.

Unless otherwise specified, the weight average molecular is measured on a specimen by gel permeation chromatography (GPC) (1200 series, Agilent Technologies) (column: Shodex LF-804, standard specimen: Shodex polystyrene), in which the specimen is obtained by dissolving a powder specimen in tetrahydrofuran (THF).

According to one embodiment of the present invention, a thermoplastic resin composition comprises: 100 parts by weight of a base resin comprising 20 to 40 wt % of (A1) a butadiene-based rubber-modified aromatic vinyl-vinyl cyanide graft copolymer, 20 to 50 wt % of (A2) an aromatic vinyl-vinyl cyanide copolymer, 5 to 25 wt % of (B) a polyamide resin, and 10 to 30 wt % of (C) an N-phenyl maleimide-styrene-maleic anhydride (PMI-SM-MAH) copolymer; and 1 to 15 parts by weight of (D) a polyether-ester-amide block copolymer.

Hereinafter, each of the components of the thermoplastic resin composition will be described in detail.

(A1) Butadiene-Based Rubber-Modified Aromatic Vinyl-Vinyl Cyanide Graft Copolymer

In one embodiment, the butadiene-based rubber-modified aromatic vinyl-vinyl cyanide graft copolymer imparts good impact resistance to the thermoplastic resin composition. In one embodiment, the butadiene-based rubber-modified aromatic vinyl-vinyl cyanide graft copolymer may have a core-shell structure in which the core is composed of a butadiene-based rubber polymer and the shell is formed by graft polymerization of an aromatic vinyl compound and a vinyl cyanide compound to the core.

The butadiene-based rubber-modified aromatic vinyl-vinyl cyanide graft copolymer may be prepared through graft polymerization of an aromatic vinyl compound and a vinyl cyanide compound to the butadiene-based rubber polymer by a typical polymerization method, such as emulsion polymerization, bulk polymerization, and the like.

The butadiene-based rubber polymer may be selected from the group consisting of a butadiene rubber polymer, a butadiene-styrene rubber polymer, a butadiene-acrylonitrile rubber polymer, a butadiene-acrylate rubber polymer, and mixtures thereof.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The butadiene-based rubber polymer forming the core of the butadiene-based rubber-modified aromatic vinyl-vinyl cyanide graft copolymer may have an average particle diameter of 0.2 to 1.0 For example, the butadiene-based rubber polymer may have an average particle diameter of 0.2 μm or more, 0.3 μm or more, 0.4 μm or more, 0.5 μm or more, 0.6 μm or more, 0.7 μm or more, 0.8 μm or more, or 0.9 μm or more, and 1.0 μm or less, 0.9 μm or less, 0.8 μm or less, 0.7 μm or less, 0.6 μm or less, 0.5 μm or less, 0.4 μm or less, or 0.3 μm or less. Within this range of the average particle diameter of the butadiene-based rubber polymer, the thermoplastic resin composition according to one embodiment and a molded product produced therefrom have good impact resistance and appearance characteristics.

Based on 100 wt % of the butadiene-based rubber-modified aromatic vinyl-vinyl cyanide graft copolymer, the butadiene-based rubber polymer may be present in an amount of 40 to 70 wt %. On the other hand, the aromatic vinyl compound and the vinyl cyanide compound grafted to the core composed of the butadiene-based rubber polymer may be present in a weight ratio of 6:4 to 8:2.

In one embodiment, the butadiene-based rubber-modified aromatic vinyl-vinyl cyanide graft copolymer may be an acrylonitrile-butadiene-styrene graft copolymer.

The butadiene-based rubber-modified aromatic vinyl-vinyl cyanide graft copolymer may be present in an amount of 20 wt % to 40 wt %, for example, 20 wt % or more, 25 wt % or more, 30 wt % or more, or 35 wt % or more, and 40 wt % or less, 35 wt % or less, 30 wt % or less, or 25 wt % or less, based on 100 wt % of the base resin. Within this range of the butadiene-based rubber-modified aromatic vinyl-vinyl cyanide graft copolymer, the thermoplastic resin composition and a molded product produced therefrom can exhibit good impact resistance and waterproof reliability.

(A2) Aromatic Vinyl-Vinyl Cyanide Copolymer

In one embodiment, the aromatic vinyl-vinyl cyanide copolymer serves to improve fluidity of the thermoplastic resin composition while securing a predetermined level of compatibility between the components thereof.

In one embodiment, the aromatic vinyl-vinyl cyanide copolymer may have a weight average molecular weight of 80,000 to 300,000 g/mol, for example, 80,000 g/mol or more, 85,000 g/mol or more, or 90,000 g/mol or more, and 300,000 g/mol or less, 250,000 g/mol or less, or 200,000 g/mol or less.

In one embodiment, the aromatic vinyl-vinyl cyanide copolymer may be prepared through polymerization of a monomer mixture comprising an aromatic vinyl compound and a vinyl cyanide compound by a typical polymerization method, such as emulsion polymerization, suspension polymerization, solution polymerization, bulk polymerization, and the like.

The aromatic vinyl compound may be selected from the group consisting of styrene, α-methyl styrene, p-methyl styrene, p-t-butyl styrene, 2,4-dimethyl styrene, chlorostyrene, vinyl toluene, vinyl naphthalene, and mixtures thereof.

The vinyl cyanide compound may be selected from the group consisting of acrylonitrile, methacrylonitrile, fumaronitrile, and mixtures thereof.

The aromatic vinyl-vinyl cyanide copolymer may comprise an aromatic vinyl compound-derived component in an amount of 55 to 80 wt %, for example, 55 wt % or more, 60 wt % or more, 65 wt % or more, 70 wt % or more, or 75 wt % or more, and 80 wt % or less, 75 wt % or less, 70 wt % or less, 65 wt % or less, or 60 wt % or less, based on 100 wt %.

In addition, the aromatic vinyl-vinyl cyanide copolymer may comprise a vinyl cyanide compound-derived component in an amount of 20 to 45 wt %, for example, 20 wt % or more, 25 wt % or more, 30 wt % or more, 35 wt % or more, or 40 wt % or more, and 45 wt % or less, 40 wt % or less, 35 wt % or less, 30 wt % or less, or wt % or less, based on 100 wt %.

In one embodiment, the aromatic vinyl-vinyl cyanide copolymer may be a styrene-acrylonitrile (SAN) copolymer.

In one embodiment, the aromatic vinyl-vinyl cyanide copolymer may be present in an amount of 20 to 50 wt %, for example, 20 wt % or more, 25 wt % or more, 30 wt % or more, 35 wt % or more, 40 wt % or more, or 45 wt % or more, and wt % or less, 45 wt % or less, 40 wt % or less, 35 wt % or less, 30 wt % or less, or wt % or less, based on 100 wt % of the base resin. Within this range of the aromatic vinyl-vinyl cyanide copolymer, the thermoplastic resin composition and a molded product produced therefrom can exhibit good formability and mechanical properties.

(B) Polyamide Resin

In one embodiment, the polyamide resin allows the thermoplastic resin composition to realize good electrical conductivity. For example, even without an excess of the (D) polyether-ester-amide block copolymer added to impart electrical conductivity to the thermoplastic resin composition, the thermoplastic resin composition according to one embodiment can exhibit good electrical conductivity when containing the polyamide resin.

In one embodiment, the polyamide resin may be selected from various polyamide resins known to those skilled in the art and may include, for example, an aromatic polyamide resin, an aliphatic polyamide resin, or a mixture thereof, without being limited thereto.

The aromatic polyamide resin is a polyamide having an aromatic group in a main chain and may be a wholly-aromatic polyamide, a semi-aromatic polyamide, or a mixture thereof.

The wholly-aromatic polyamide means a polymer of an aromatic diamine and an aromatic dicarboxylic acid, and the semi-aromatic polyamide means an aromatic polyamide containing at least one aromatic unit and at least one non-aromatic unit between amide bonds. For example, the semi-aromatic polyamide may be a polymer of an aromatic diamine and an aliphatic dicarboxylic acid or a polymer of an aliphatic diamine and an aromatic dicarboxylic acid.

The aliphatic polyamide means a polymer of an aliphatic diamine and an aliphatic dicarboxylic acid.

The aromatic diamine may include, for example, p-xylene diamine, m-xylene diamine, and the like, without being limited thereto. These may be used alone or as a mixture thereof.

The aromatic dicarboxylic acid may include, for example, phthalic acid, isophthalic acid, terephthalic acid, 2,6-naphthalenedicarboxylic acid, (1,3-phenylenedioxy)diacetic acid, and the like, without being limited thereto. These may be used alone or as a mixture thereof.

The aliphatic diamine may include, for example, ethylenediamine, trimethylenediamine, hexamethylenediamine, dodecamethylenediamine, piperazine, and the like, without being limited thereto. These may be used alone or as a mixture thereof.

The aliphatic dicarboxylic acid may include, for example, adipic acid, sebacic acid, succinic acid, glutaric acid, azelaic acid, dodecanedioic acid, dimeric acid, cyclohexanedicarboxylic acid, and the like, without being limited thereto. These may be used alone or as a mixture thereof.

In one embodiment, the polyamide resin may comprise polyamide 6, polyamide 66, polyamide 46, polyamide 11, polyamide 12, polyamide 610, polyamide 612, polyamide 61, polyamide 6T, polyamide 4T, polyamide 410, polyamide 510, polyamide 1010, polyamide 1012, polyamide 10T, polyamide 1212, polyamide 12T, polyamide MXD6, or a combination thereof.

In one embodiment, the polyamide resin may comprise at least polyamide 6.

In one embodiment, the polyamide resin may be present in an amount of 5 to 40 wt %, for example, 5 to 35 wt %, for example, 5 to 30 wt %, for example, 5 to 25 wt %, for example, 5 to 20 wt %, based on 100 wt % of the base resin.

Within this range of the polyamide resin, the thermoplastic resins composition and a molded product produced therefrom can exhibit good mechanical properties and electrical conductivity.

(C)N-Phenyl Maleimide-Styrene-Maleic Anhydride (PMI-SM-MAH) Copolymer

In one embodiment, the N-phenyl maleimide-styrene-maleic anhydride copolymer serves to reduce surface resistance while preventing bubble generation upon electrostatic painting of the thermoplastic resin composition, thereby securing good external appearance and good painting adhesion.

In one embodiment, the N-phenyl maleimide-styrene-maleic anhydride copolymer may be prepared through polymerization of a mixture of N-phenyl maleimide, styrene, and maleic anhydride, or through imidization of styrene and a maleic anhydride copolymer.

In one embodiment, the N-phenyl maleimide-styrene-maleic anhydride copolymer may comprise 10 to 55 wt %, for example, 15 to 55 wt %, or 15 to 50 wt %, of an N-phenyl maleimide-derived component, 40 to 80 wt % of a styrene-derived component, and 1 to 10 wt % of a maleic anhydride-derived component.

Within this range of the N-phenyl maleimide-styrene-maleic anhydride copolymer, the thermoplastic resin composition and a molded product produced therefrom can exhibit good electrical conductivity and waterproof reliability.

The N-phenyl maleimide-styrene-maleic anhydride copolymer has a glass transition temperature (Tg) of 145 to 200° C., for example, 155 to 200° C., or for example, 165 to 200° C., without being limited thereto.

The N-substituted maleimide-styrene-maleic anhydride copolymer may have a weight average molecular weight (Mw) of 10,000 to 300,000 g/mol, for example, 15,000 to 150,000 g/mol. Within this range of the N-substituted maleimide-styrene-maleic anhydride copolymer, the thermoplastic resin composition and a molded product produced therefrom can exhibit good electrical conductivity while maintaining good property balance.

In one embodiment, the N-phenyl maleimide-styrene-maleic anhydride copolymer may be present in an amount of 10 to 30 wt %, for example, 10 wt % or more, 15 wt % or more, 20 wt % or more, or 25 wt % or more, and 30 wt % or less, 25 wt % or less, 20 wt % or less, or 15 wt %, based on 100 wt % of the base resin. Within this range, the thermoplastic resin composition and a molded product produced therefrom can exhibit good electrical conductivity and waterproof reliability.

(D) Polyether-Ester-Amide Block Copolymer

In one embodiment, the polyether-ester-amide block copolymer allows the thermoplastic resin composition and a molded product produced therefrom to exhibit a predetermined level of electrical conductivity.

In addition, the polyether-ester-amide block copolymer allows the thermoplastic resin composition and a molded product produced therefrom to exhibit such electrical conductivity while maintaining good waterproof reliability.

In one embodiment, the polyether-ester-amide block copolymer may be, for example, a reaction mixture comprising an amino-carboxylic acid, lactam or diamine-dicarboxylic acid salt having 6 or more carbon atoms; a polyalkylene glycol; and a dicarboxylic acid having 4 to 20 carbon atoms.

In one embodiment, the aminocarboxylic acid, lactam, or diamine-dicarboxylic acid salt having 6 or more carbon atoms may include aminocarboxylic acids, such as ω-aminocaproic acid, ω-aminoenanthic acid, ω-aminocaprylic acid, ω-aminopelargonic acid, ω-aminocapric acid, 11-aminoundecanoic acid, 12-aminododecanoic acid, and the like; lactams, such as ε-caprolactam, enantolactam, capryl lactam, laurolactam, and the like; and salts of diamines and dicarboxylic acids, such as salts of hexamethylenediamine-adipic acid, salts of hexamethylenediamine-isophthalic acid, and the like. For example, 12-aminododecanoic acid, ε-caprolactam, and salts of hexamethylenediamine-adipic acid, and the like may be used.

In one embodiment, the polyalkylene glycol may include polyethylene glycol, polytetramethylene glycol, polyhexamethylene glycol, a block or random copolymer of ethylene glycol and propylene glycol, a copolymer of ethylene glycol and tetrahydrofuran, and the like. For example, polyethylene glycol, a copolymer of ethylene glycol and propylene glycol, and the like may be used.

In one embodiment, the dicarboxylic acid having 4 to 20 carbon atoms may include terephthalic acid, 1,4-cyclohexanedicarboxylic acid, sebacic acid, adipic acid, dodecanedioic acid, and the like.

In one embodiment, a bond between the aminocarboxylic acid, lactam or diamine-dicarboxylic acid salt having 6 or more carbon atoms and the polyalkylene glycol may be an ester bond; a bond between the aminocarboxylic acid, lactam or diamine-dicarboxylic acid salt having 6 or more carbon atoms and the dicarboxylic acid having 4 to 20 carbon atoms may be an amide bond; and a bond between the polyalkylene glycol and the dicarboxylic acid having 4 to 20 carbon atoms may be an ester bond.

In one embodiment, the polyether-ester-amide block copolymer may be prepared by a method well-known in the art, for example, by a method disclosed in JP Patent Publication No. S56-045419 or JP Unexamined Patent Publication No. S55-133424.

In one embodiment, the polyether-ester-amide block copolymer may comprise 10 to 95 wt % of a polyether-ester block. Within this range, the thermoplastic resin composition can exhibit good electrical conductivity, heat resistance, and the like.

In one embodiment, the polyether-ester-amide block copolymer may be present in an amount of 1 to 15 parts by weight, for example, 1 part by weight or more, 5 parts by weight or more, or 10 parts by weight or more, and 15 parts by weight or less, 10 parts by weight or less, or 5 parts by weight or less, relative to 100 parts by weight of the base resin. Within this range of the polyether-ester-amide block copolymer, the thermoplastic resin composition and a molded product produced therefrom can exhibit good electrical conductivity while maintaining good waterproof reliability.

(E) Additive

In addition to the components (A1) to (D), the thermoplastic resin composition according to one embodiment may further comprise at least one type of additive in order to secure property balance while securing good properties in terms of flame retardancy, antibacterial properties, weather resistance, light resistance, impact resistance, heat resistance, and appearance characteristics, or according to final purpose of the thermoplastic resin composition, as needed.

Specifically, the additives may include nucleating agents, coupling agents, fillers, plasticizers, impact modifiers, flame retardants, lubricants, antibacterial agents, release agents, heat stabilizers, antioxidants, UV stabilizers, pigments, dyes, and the like. These may be used alone or in combination thereof.

These additives may be present in a suitable amount within the range not causing deterioration in properties of the thermoplastic resin composition, specifically in an amount of 20 parts by weight or less relative to 100 parts by weight of the base resin, without being limited thereto.

The thermoplastic resin composition according to the present invention may be prepared by a typical method known to those skilled in the art.

For example, the thermoplastic resin composition according to the present invention may be prepared in pellet form by simultaneously mixing the aforementioned components of the present invention and other additives, followed by melt kneading in an extruder.

Another embodiment of the present invention provides a molded product produced from the thermoplastic resin composition according to the embodiments of the present invention. The molded product may be produced from the thermoplastic resin composition by various methods known in the art, such as injection molding, extrusion molding, and the like.

As such, the molded product has good properties in terms of electrical conductivity, impact resistance, painting adhesion, and waterproof reliability, and thus can be advantageously applied to various electric/electronic products, building materials, sports products, and interior/exterior parts of automobiles.

Next, the present invention will be described in more detail with reference to some examples. It should be understood that these examples are provided for illustration only and are not to be in any way construed as limiting the present invention.

### Examples 1 and 2 and Comparative Examples 1 to 5

Thermoplastic resin compositions of Examples 1 and 2 and Comparative Examples 1 to 5 were prepared in composition ratios as listed in Table 1.

In Table 1, (A1), (A2), (B), (C) and (C′) are included in a base resin and are represented in wt % based on the total weigh of the base resin, and (D) included in a base resin is represented in parts by weight relative to 100 parts by weight of the base resin.

The components listed in Table 1 were subjected to dry mixing and continuously supplied in quantitative amounts to a twin-screw extruder (L/D=44, Φ=35 mm), followed by melting/kneading, thereby preparing a thermoplastic resin composition in pellet form. Then, specimens for evaluation of properties were prepared by drying the thermoplastic resin composition prepared in pellet form at 80° C. for about 2 hours, followed by injection molding using a 6 oz injection molding machine at a cylinder temperature of about 250° C. and a mold temperature of about 60° C.

TABLE 1

| | | Example | Example | Comparative | Comparative | Comparative | Comparative | Comparative |
|---|---|---|---|---|---|---|---|---|
| Item | | 1 | 2 | Example 1 | Example 2 | Example 3 | Example 4 | Example 5 |
| (A1) | wt % | 30 | 30 | 30 | 30 | 30 | 30 | 30 |
| (A2) | wt % | 40 | 35 | 55 | 50 | 20 | 35 | 35 |
| (B) | wt % | 15 | 15 | 15 | 15 | 15 | 15 | 15 |
| (C) | wt % | 15 | 20 | — | 5 | 35 | 20 | 1 |
| (C′) | wt % | — | — | — | — | — | — | 20 |
| (D) | parts by | 8 | 8 | 8 | 8 | 8 | — | 8 |
| | weight | | | | | | | |

Details of the components listed in Table 1 are as follows.

(A1) Butadiene-Based Rubber-Modified Aromatic Vinyl-Vinyl Cyanide Graft Copolymer

Acrylonitrile-butadiene-styrene graft copolymer (Lotte Chemical Corp.) comprising about 58 wt % of a core (average particle diameter: about 0.25 μm) composed of a butadiene rubber polymer and a shell formed by graft polymerization of acrylonitrile and styrene (acrylonitrile: styrene=about 2.5:7.5 (weight ratio)) to the core

(A2) Aromatic Vinyl-Vinyl Cyanide Copolymer

Styrene-acrylonitrile copolymer (Lotte Chemical Corp.) prepared through copolymerization of a monomer mixture comprising about 28 wt % of acrylonitrile and about 72 wt % of styrene and having a weight average molecular weight of about 110,000 g/mol

(B) Polyamide Resin

Polyamide 6 having a melting point (Tm) of about 223° C. and a relative viscosity of about 2.3 (EN-300, KP ChemTech Co., Ltd.)

(C)N-Phenyl Maleimide-Aromatic Vinyl-Maleic Anhydride Copolymer

N-phenyl maleimide-styrene-maleic anhydride copolymer having a glass transition temperature (Tg) of about 196° C. and containing about 49 wt % of an N-phenyl maleimide-derived component (MS-NB, Denka Co., Ltd.)

(C′) Maleic Anhydride-Aromatic Vinyl-Vinyl Cyanide Copolymer

Maleic anhydride-styrene-acrylonitrile copolymer (SAM-010, Fine Blend Polymer Co., Ltd.)

(D) Polyether-Ester-Amide Block Copolymer

Polyamide 6-polyethylene oxide block copolymer (PA6-b-PEO, PELECTRON AS, Sanyo Chemical Ind., Ltd.)

### Experimental Example

Experimental results are shown in Table 2.
(1) Electrical conductivity (unit: Ω/sq): Surface resistance was measured on a specimen having a size of 100 mm×100 mm×2 mm using a surface resistance meter (Manufacturer: SIMCO-ION, Model: Work surface Tester ST-4). Lower surface resistance indicates better electrical conductivity.
(2) Impact resistance (unit: kgf·cm/cm): Notched Izod impact strength was measured on a ¼″ thick specimen in accordance with ASTM D256.
(3) Waterproof reliability: After a specimen having a size of 100 mm×100 mm×2 mm was dipped in warm water at 60±2° C. for 96 hours to be washed therewith, the water was blown off using an air blower, and the specimen was dried and left under standard conditions (23±2° C., 50±5% RH) for 1 hour, followed by observation of discoloration to evaluate waterproof properties. After evaluation of waterproof properties, waterproof reliability was evaluated by checking generation of bubbles on the surface of the specimen.
(X: No bubble generation, ∘: Generation of bubbles in some region on surface, ⊚: generation of bubbles over specimen)
(4) Painting adhesion (unit: grade): A specimen subjected to electrostatic painting and having a size of 100 mm×100 mm×2 mm was carved at an interval of 1 mm in a lattice shape and a tape was attached to and detached from the specimen to evaluate the grade of surface state in accordance with ASTM D3359. A JIS Z 1522 standard Nichiban CT-24 Tape was used for evaluation.

TABLE 2

| | | | Comparative | Comparative | Comparative | Comparative | Comparative |
|---|---|---|---|---|---|---|---|
| Item | Example 1 | Example 2 | Example 1 | Example 2 | Example 3 | Example 4 | Example 5 |
| Surface resistance | 10^{10.5} | 10^{10.5} | 10^{9.9} | 10^{10.2} | 10^{11.8} | 10^{13.5} | 10^{10.6} |
| Impact strength | 20.4 | 19.5 | 15.5 | 22.6 | 16.2 | 10.3 | 17.8 |
| Bubble generation | X | X | ◯ | ⊚ | ◯ | ◯ | ◯ |
| Painting adhesion | 5B | 5B | 0B | 0B | 3B | 1B | 4B |

From Tables 1 and 2, it can be seen that, when the thermoplastic resin composition is formed using suitable amounts of the butadiene-based rubber-modified aromatic vinyl-vinyl cyanide graft copolymer, the aromatic vinyl-vinyl cyanide copolymer, the polyamide resin, the maleic anhydride-aromatic vinyl-maleic anhydride, and the polyether-ester-amide block copolymer as in Examples 1 and 2, the thermoplastic resin composition and a molded product produced therefrom have better properties in term of electrical conductivity, impact resistance, waterproof reliability, and painting adhesion than the thermoplastic resin compositions of Comparative Examples.

Although some exemplary embodiments have been described above, it should be understood that the present invention is not limited thereto and various modifications, changes, alterations, and equivalent embodiments can be made by those skilled in the art without departing from the spirit and scope of the invention.

1. A thermoplastic resin composition comprising:
100 parts by weight of a base resin comprising 20 to 40 wt % of (A1) a butadiene-based rubber-modified aromatic vinyl-vinyl cyanide graft copolymer, 20 to 50 wt % of (A2) an aromatic vinyl-vinyl cyanide copolymer, 5 to 25 wt % of (B) a polyamide resin, and 10 to 30 wt % of (C) an N-phenyl maleimide-styrene-maleic anhydride (PMI-SM-MAH) copolymer; and
1 to 15 parts by weight of (D) a polyether-ester-amide block copolymer.

2. The thermoplastic resin composition according to claim 1, wherein the (A1) butadiene-based rubber-modified aromatic vinyl-vinyl cyanide graft copolymer has a core-shell structure in which the core is composed of a butadiene-based rubber polymer and the shell is formed by graft polymerization of an aromatic vinyl compound and a vinyl cyanide compound to the core.

3. The thermoplastic resin composition according to claim 2, wherein the butadiene-based rubber polymer has an average particle diameter of 0.2 to 1.0 μm.

4. The thermoplastic resin composition according to claim 1, wherein the (A1) butadiene-based rubber-modified aromatic vinyl-vinyl cyanide graft copolymer is an acrylonitrile-butadiene-styrene graft (g-ABS) copolymer.

5. The thermoplastic resin composition according to claim 1, wherein the (A2) aromatic vinyl-vinyl cyanide copolymer comprises 55 to 80 wt % of an aromatic vinyl compound-derived component and 20 to 45 wt % of a vinyl cyanide compound-derived component based on 100 wt %.

6. The thermoplastic resin composition according to claim 1, wherein the (A2) aromatic vinyl-vinyl cyanide copolymer has a weight average molecular weight of 80,000 to 300,000 g/mol.

7. The thermoplastic resin composition according to claim 1, wherein the (A2) aromatic vinyl-vinyl cyanide copolymer is a styrene-acrylonitrile copolymer.

8. The thermoplastic resin composition according to claim 1, wherein the (B) polyamide resin comprises polyamide 6, polyamide 66, polyamide 46, polyamide 11, polyamide 12, polyamide 610, polyamide 612, polyamide 61, polyamide 6T, polyamide 4T, polyamide 410, polyamide 510, polyamide 1010, polyamide 1012, polyamide polyamide 1212, polyamide 12T, polyamide MXD6, or a combination thereof.

9. The thermoplastic resin composition according to claim 1, wherein the (C)N-phenyl maleimide-styrene-maleic anhydride (PMI-SM-MAH) copolymer comprises 20 to 55 wt % of an N-phenyl maleimide-derived component based on 100 wt %.

10. The thermoplastic resin composition according to claim 1, wherein the (C)N-phenyl maleimide-styrene-maleic anhydride (PMI-SM-MAH) copolymer has a glass transition temperature (Tg) of 150 to 200° C.

11. The thermoplastic resin composition according to claim 1, wherein the (D) polyether-ester-amide block copolymer is a reaction mixture of: an aminocarboxylic acid, lactam, or diamine-dicarboxylic acid salt having 6 or more carbon atoms; a polyalkylene glycol; and a dicarboxylic acid having 4 to 20 carbon atoms.

12. The thermoplastic resin composition according to claim 1, further comprising: at least one additive selected from flame retardants, nucleating agents, coupling agents, fillers, plasticizers, impact modifiers, lubricants, antibacterial agents, release agents, heat stabilizers, antioxidants, UV stabilizers, pigments, and dyes.

13. A molded product produced from the thermoplastic resin composition according to claim 1.
